(19) United States
(12) Patent Application Publication
(10) Pub. No.: US 2002/0121803 A1
(43) Pub. Date: Sep. 5, 2002

(54) Ten way power adjustable seat

(76) Inventor: Paul T. Schooler, Fraser, MI (US)

Correspondence Address: Anthony P. Cho, CARLSON, GASKEY & OLDS, P.C., Ste. 350, 400 W. Maple Rd., Birmingham, MI, 48009, US

(21) Appl. No.: 09/797,976

(22) Filed: Mar. 2, 2001

(51) Int. Cl. B60N 2/02

(52) U.S. Cl. 297/330

(57) ABSTRACT

The adjustable seat assembly comprises a seat, backrest, and headrest. At least one guide with a slope supported for movement along a path is provided. A seat is operatively connected to the slope and supported to permit movement of the seat along the slope without movement along the path of the guide. The backrest has at least a first pivot operatively connecting the backrest to the seat as well as a threaded member axially supported for rotation and operatively connected to the backrest so as to permit movement of the backrest by rotation of the threaded member. A second pivot operatively connects the threaded member to the backrest. Moreover, a headrest is operatively connected to the backrest. Another threaded member is axially supported for rotation and operatively connected to the headrest so as to permit movement of the headrest by rotation of the second threaded member. Finally, a frame is slidably connected to the seat

### BACKGROUND OF THE INVENTION

This invention relates to a power adjustable seat.

Power seating systems currently employ complex mechanisms and linkages to provide the ability to adjust the seat, backrest, and headrest. Such systems are heavy and require time-consuming assembly operations. They are also expensive to manufacture.

Moreover, the design of these systems may affect the vehicle's overall fuel economy. While the weight of these systems decreases the fuel efficiency of the vehicle, so too does the height of such systems. A tall seat requires a high ceiling in the vehicle's interior to accommodate the driver or passenger in the seat. In turn, this raised ceiling increases the drag of the vehicle and thereby reduces its fuel economy.

In particular, current mechanisms used to raise and lower the seat in the vehicle contribute to the complexity of power seating design. One such system raises and lowers the seat through the actuation of four threaded rods that raise and lower the seat. Two mechanically linked threaded rods raise and lower the front end of the seat while two mechanically linked threaded rods raise and lower the back end of the seat.

Another proposed system employs a stationary incline that draws a support up and down its slope to thereby raise and lower the seat. Such a system, however, fails to permit the raising and lowering of the front end independently from the back end. Moreover, the design further requires the seat to move forward as the seat is drawn up the slope and to move back as the seat is drawn down. The design therefore does not permit the raising and lowering of the seat independently from the forward and backward adjustment of the seat.

A need therefore exists for a simplified adjustable seat design that avoids the complex mechanisms and linkages for adjusting the seat while still offering independent operation of each seat adjustment.

### SUMMARY OF THE INVENTION

In a disclosed embodiment of this invention, the adjustable seat assembly comprises at least one guide with a slope supported for movement along a path and a seat connected to the slope and supported to permit movement of the seat along the slope without movement along the path of the guide. The adjustable seat assembly may also have a backrest with a first pivot connecting the backrest to the seat, a first threaded rod supported for rotation and connected to the backrest so as to permit movement of the backrest by rotation of the rod, and a second pivot operatively connecting the threaded rod to the backrest. To provide additional freedom of adjustment, a headrest is connected to the backrest and has a second threaded rod supported for rotation and connected to the headrest to permit movement of the headrest by rotation of the second rod. The adjustable seat assembly also includes a frame operatively connected to the seat to permit sliding of the seat on the frame.

Moreover, a support may be employed to connect the seat to the slope. The support is constrained from moving along the path of the guide and is supported to permit movement of the support along the slope of the guide. In this way, the seat may move along the slope of the guide without moving along the path of the guide. The guide is preferably an incline.

Connecting the guide to the motor is a threaded rod supported for rotation so as to permit movement of the guide along its path by rotation of the threaded rod. The threaded member may be connected to a motor. This embodiment permits either the seat to rise without complex linkages and mechanisms.

To permit the raising or lowering of the front or rear of the seat, simultaneously or independent, a seat with a front end and a rear end is connected to at least a first guide with a first slope sloping upward toward the front end and at least a second guide with a second slope sloping upward toward the rear end. The seat is connected to these slopes so as to permit movement of the seat along the first slope and the second slope. By moving both inclines toward each other, the seat is raised. By moving the inclines apart, the seat is lowered. Moving one incline without the other permits raising and lowering of each end, or tilting.

Both first guide and second guide are supported to permit movement along a path. The support may permit movement of the seat along the first slope and the second slope without movement along the path of the guides. Both guides may be linked to threaded rods and motors to permit their simultaneous and independent movement and consequently simultaneous and independent movement of the front end and rear end of the seat.

With respect to the backrest, the adjustable seat includes a backrest with at least a first pivot operatively connecting the backrest to the seat, a threaded rod supported for rotation and connected to the backrest to permit movement of the backrest by rotation of the threaded rod, and a second pivot connecting the rod to the backrest. The first pivot permits the backrest to pivot relative to the seat while the second pivot prevents the binding of the threaded rod that may be caused by a person sitting on the seat. The second pivot may be a ball joint. The rod is also connectable to a motor to permit the reclining and inclining of the backrest.

Preferably the backrest also has an adjustable headrest. Unlike headrests currently available, the headrest of this assembly is powered by a motor for up and down movement. Moreover, the headrest is connected to the backrest by a threaded rod member supported for rotation to permit movement of the headrest by rotation of the threaded rod.

This assembly thereby provides ten adjustments. The seat may slide forward and backward on the frame, providing two adjustments. Additionally, the seat may also rise and drop on the slope of the guide, both front end and back end together or separately, permitting the seat to adjust in four ways. Two other adjustments are provided by the backrest, which may pivot back and forth relative to the seat. Finally, the headrest may rise and drop as well, providing two other adjustments. In total, all of these adjustments may be powered by only five motors due to the simplicity of the adjustable seat assembly's design.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 shows an embodiment of the invention, the entire seat assembly.

FIG. 2 shows a perspective view of the guides of the seat assembly of FIG. 1, which permit the raising and lowering of the seat.

FIG. 3A shows a side view of the guides of FIG. 2 in relation to the threaded members and support of the seat.

FIG. 3B shows the side view of the guides of FIG. 2 positioned so that one end of the seat is raised relative to the other end.

FIG. 3C shows the side view of the guides of FIG. 2 positioned so that both ends of the seat are raised.

FIG. 4 shows the backrest of FIG. 1, displaying the backrest and first and second pivots.

FIG. 5 shows an above view of the backrest of FIG. 4, including backrest, first pivot and second pivot.

FIG. 6 shows a cross section of the second pivot of FIGS. 4 and 5 including ball joint pivot and threaded member.

FIG. 7 shows a side view of the frame of FIG. 1 along with rollers to permit sliding of seat along frame.

### DETAILED DESCRIPTION OF THE PREFERRED EMBODIMENT

The adjustable seat assembly permits ten adjustments. The seat may slide forward and backward on the frame and the seat may also rise and drop, both front end and rear end together or separately. Two other adjustments are provided by the backrest, which may pivot back and forth relative to the seat. Finally, the headrest may rise and drop as well.

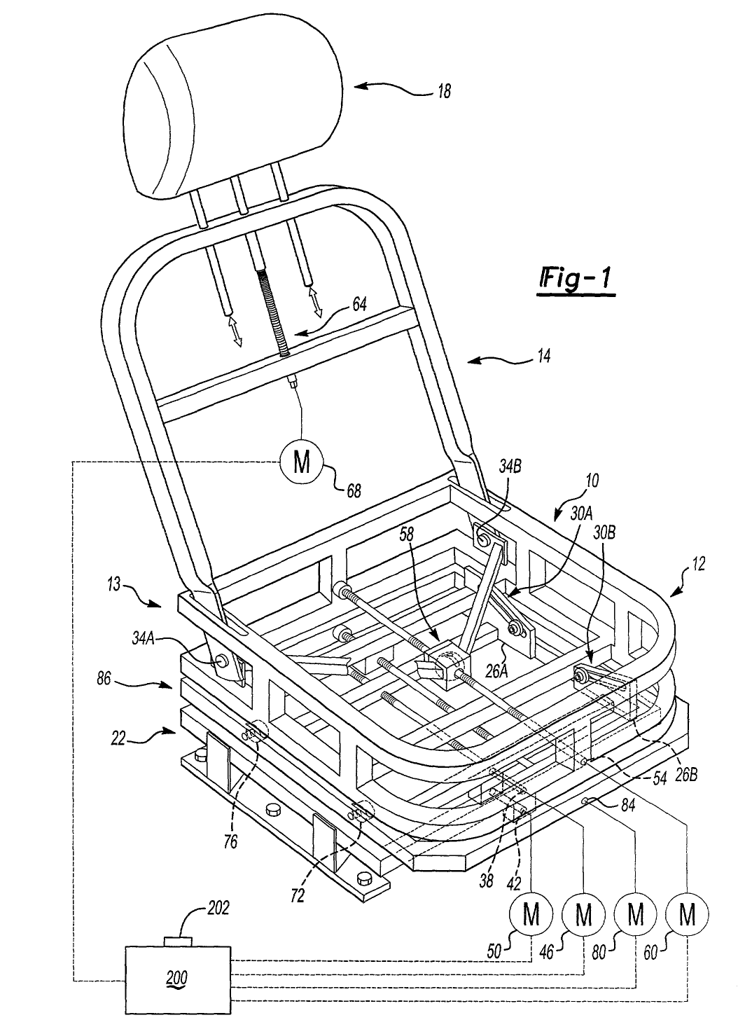

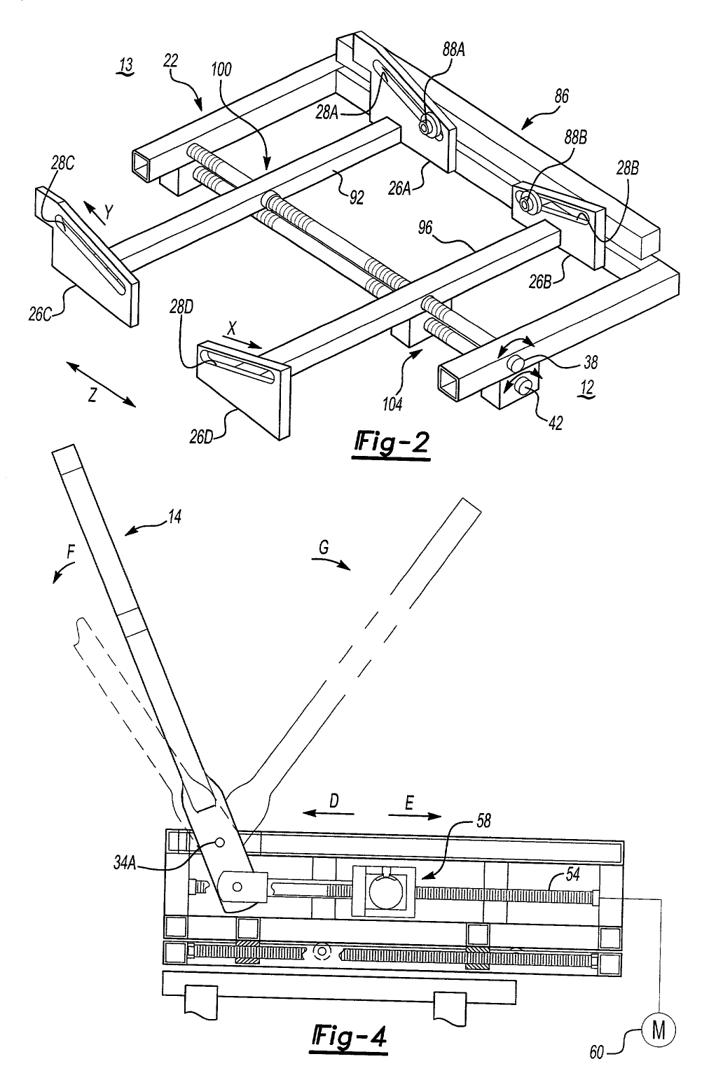

FIG. 1 shows an embodiment of the invention. The seat assembly comprises generally seat 10, backrest 14, and headrest 18. All elements are ultimately supported by frame 22. Seat 10 rides on four guides 26A, 26B, 26C, and 26D (only 26A and 26B can be seen from this perspective). Each guide (26A, 26B, 26C, and 26D) has a slope (28A, 28B, 28C, and 28D) to which seat 10 is operatively connected to permit movement of seat 10 along these slopes. Seat 10 has front end 12 and rear end 13. Guides 26A, 26B, 26C and 26D (FIG. 2) are shown as inclines although one of ordinary skill in the art could employ other shapes to affect different types of movement of seat 10. Seat 10 further has threaded members 38 and 42, such as a threaded rod, axially supported for rotation and operatively connected to guides 26A, 26B, 26C and 26D so as to permit their linear movement. Guides 26A and 26C are operatively connected to threaded member 38 while guides 26B and 26D are operatively connected to threaded member 42. Preferably, threaded members 38 and 42 are each operatively connected to motors 46 and 50, respectively, such as through motion transmitting flex cables as known in the art. Actuation of motor 46 powers movement of guides 26A and 26C (not pictured in FIG. 1) to cause rear end 13 of seat 10 to raise or lower. Actuation of motor 50 powers movement of guides 26B and 26D to cause front end 12 of seat 10 to raise or lower. Actuation of both motors 46 and 50 permits the raising or lowering of front end 12 and rear end 13 simultaneously.

Backrest 14 has at least first pivot (34A and 34B) operatively connecting backrest 14 to seat 10. Threaded member 54 is axially supported for rotation and operatively connected to backrest 14 so as to permit movement of backrest 14 by rotation of threaded member 54. Second pivot 58 operatively connects threaded member 54 to backrest 14. Motor 60 provides rotational movement to threaded member 54 to cause backrest 14 to recline or incline.

Headrest 18 is operatively connected to backrest 14 through threaded member 64. Threaded member 64 is axially supported for rotation and operatively connected to headrest 18 so as to permit movement of headrest 18 by rotation of threaded member 64. Motor 68 provides rotational movement to threaded member 64 to raise and lower headrest.

Headrest 18, backrest 14, and seat 10 are all operatively connected and supported by frame 22. Rollers 72 and 76 as well as two rollers on the other side of seat 10 are on support 86 and provide a slidable connection between support 86 and seat 10. Motor 60 is operatively connected to threaded rod 84, which is operatively connected to seat 10. Rotational movement from motor permits seat 10 to slide back and forth under power.

A control 200 communicates with an operator input switch system 202 which allows the operator to move the seat to various positions. Obviously, switch system 202 would include several switches.

FIG. 2 shows in greater detail the arrangement of guides 26A, 26B, 26C, and 26D. Front end 12 and rear end 13 of seat 10 are shown schematically by their approximate location. Guides 26B and 26D have slopes 28B and 28D, respectively, sloping upward toward front end 12 as indicated by arrow X while guides 26A and 26C have slopes 28A and 28C, respectively, sloping upward toward rear end 13 as indicated by arrow Y. Seat 10 is operatively connected to these slopes through support 86, which includes pins 88A and 88B as well as two pins on the other side of seat 10 (not pictured here).

Guides 26A and 26C are interconnected by bar 92 while guides 26B and 26D are interconnected by bar 96. Bar 92 is threaded at point 100 coupling rotational movement of threaded member 38 to bar 92. Accordingly, turning of threaded member 38 advances guides 26A and 26C along path Z toward front end 12 or rear end 13.

Guides 26B and 26D are interconnected by bar 96. Bar 96 is threaded at point 104, coupling rotational movement of threaded member 42 to bar 96. As threaded member 42 turns, guides 26B and 26D move along path Z toward front end 12 or rear end 13. Threaded member 38 simply passes through bar 96, which is not threaded for threaded member 38.

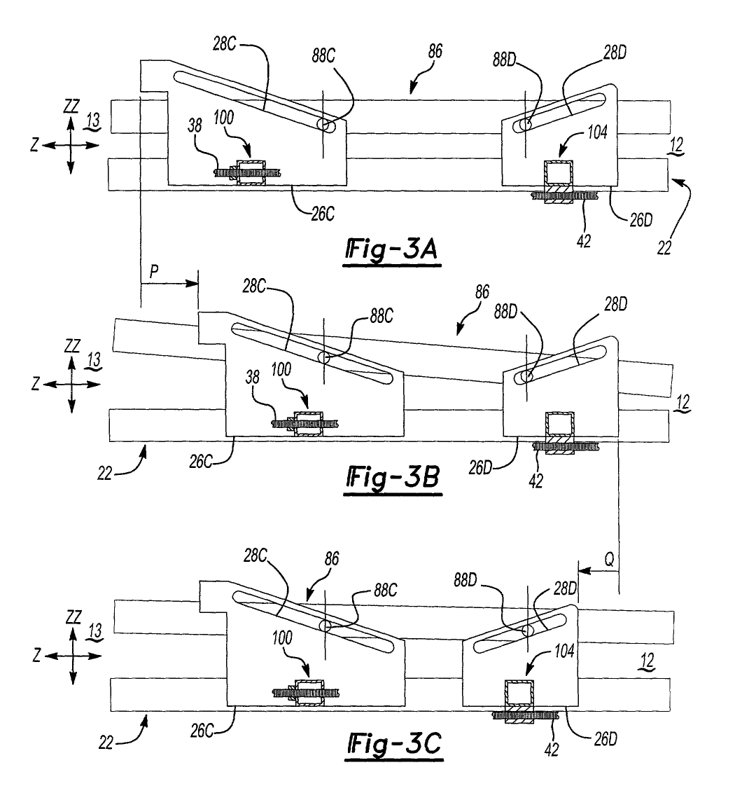

As seen in FIGS. 3A, 3B, and 3C, the movement of guides 26A, 26B, 26C, and 26D controls the raising and lowering of seat 10, front end 12 and rear end 13, independently or simultaneously. In FIG. 3A, guide 26C is shown interconnected to threaded member 38 at point 100 so that rotation of threaded member 38 moves guide 26C along path Z. Also, guide 26D is shown interconnected to threaded member 42 at point 104 such that rotation of threaded member 42 moves guide 26D along path Z. Both pins 88C and 88D and therefore support 86 are constrained against moving along path Z. Seat 10 is operatively connected to support 86. However, they are free to move along ZZ or any other axis between Z and ZZ.

Accordingly, as shown in FIG. 3B, movement of point 100 by rotation of threaded rod 38 causes guide 26C to move in direction of arrow P. Pin 88C follows slope 28C raising support 86 in such a way as to lift rear end 13 of seat 10. Rotation of threaded rod 38 in the opposite direction causes rear end 13 to lower.

As seen in FIG. 3C, rotation of threaded rod 42 moves point 104 in direction of arrow Q. Pin 88D follows slope 28D raising support 86 in such a way as to lift front end 12 of seat 10. Rotation of threaded rod 42 in the opposite direction causes front end 12 to lower.

In this way, the height of front end 12 and rear end 13 and consequently seat 10 are adjustable. This means of adjustment is accomplished without travel of support 86 and consequently seat 10 in direction of path Z, permitting the raising and lowering of seat 10 without forward or rearward travel of seat 10 in contrast to Brusasco U.S. Pat. No. 4,944, 555. Moreover, further unlike the prior art, the moving guides permit raising and lower of front end 12 and rear end 12 independently of each other.

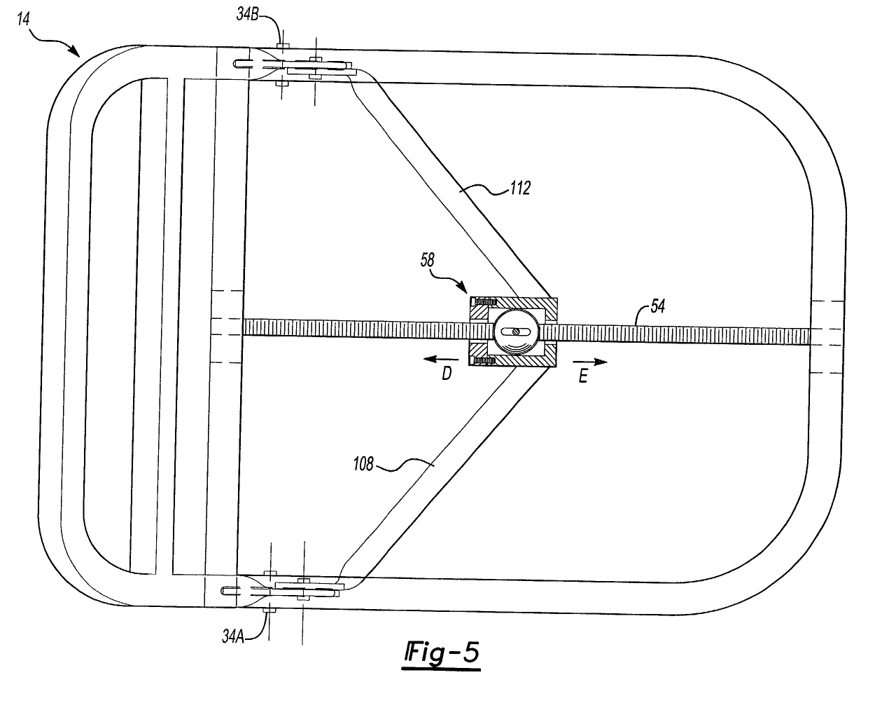

FIGS. 4 and 5 illustrate another feature of the invention. Backrest 14 is pivotally connected to seat 10 at by pivot 34A and 34B (not pictured in FIG. 4).

Threaded member 54 as well as another pivot 58, a ball joint, are shown with motor 60 (FIG. 4). Rotation of threaded member 54 moves pivot 58 along threaded member 54. As seen in FIG. 5, pivot 58 is pivotally connected to arms 108 and 112, which in turn are operatively connected to backrest 14 through pivots 34A and 34B.

Movement of pivot 58 along threaded member 54 accordingly causes backrest 14 to pivot as seen in FIG. 4. Movement of pivot 58 in direction of arrow E pivotally moves backrest 14 in direction of arrow F while movement of pivot 58 in direction of arrow D pivotally moves backrest 14 in direction of arrow G.

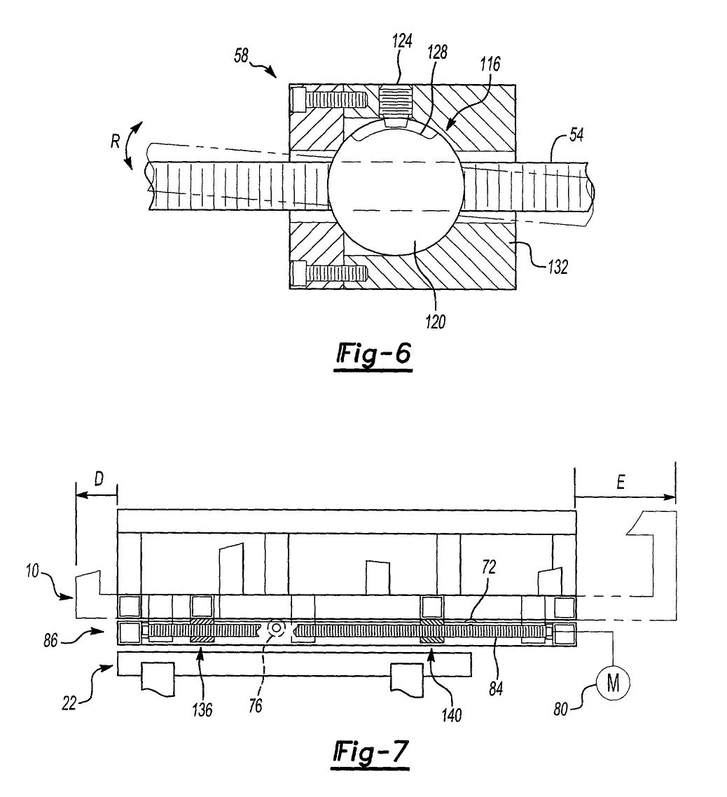

FIG. 6 shows in detail pivot 58. Shown are thread member 54 and ball joint 116. Ball joint 116 includes ball 120, pin 124, and groove 128 for pin 124. Ball 120 is threaded to couple rotational movement of threaded member 54 and cause movement of arms 108 and 112 (shown in FIG. 5) in direction of arrows D or E. Ball 116 is free to pivot along path of arrow R within housing 132. However, ball 116 is prevented from rotating other than along path of arrow R by pin 124 and groove 128. Ball joint 116 creates a pivotal connection between arms 108 and 112 and threaded member 54 and ultimately backrest 14. This feature alleviates binding of threaded member 54 on housing 132 that may result from load on seat 10 by according thread member 54 play within housing 132. Ball joint 116 thereby permits threaded member 54 to pivot along path R and thereby adjust for load on seat 10.

FIG. 7 shows a detail view of the embodiment of the invention permitting forward and back motion of seat 10. Shown are seat 10, support 86, rollers 76 and 72, frame 22, and motor 80. Seat 10 is slidably connected to support 86 through rollers 76 and 72 as well as matching rollers on the other side of seat 10 (not pictured). Support 86 is operatively connected to threaded member 84 through threaded connections 136 and 140. Thus, when motor 80 rotates threaded member 84, support 86 is movable in direction of arrows D and E.

The aforementioned description is exemplary rather then limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

What is claimed is:

1. An adjustable seat assembly comprising:
at least one guide with a slope supported for movement along a path; and
a seat operatively connected to said slope and supported to permit movement of said seat along said slope without movement along said path of said guide.

2. The adjustable seat assembly of claim 1 further including a support operatively connecting said seat to said slope and constrained from moving along said path so as to permit movement of said seat along said slope without movement along said path of said guide.

3. The adjustable seat assembly of claim 1 further including a backrest with at least a first pivot operatively connecting said backrest to said seat, a first threaded member axially supported for rotation and operatively connected to said backrest so as to permit movement of said backrest by rotation of said first threaded member, and a second pivot operatively connecting said first threaded member to said backrest.

4. The adjustable seat assembly of claim 3 further including a headrest operatively connected to said backrest and a second threaded member axially supported for rotation and operatively connected to said headrest so as to permit movement of said headrest by rotation of said second threaded member.

5. The adjustable seat assembly of claim 1 wherein said guide is an incline.

6. The adjustable seat assembly of claim 1 further including a threaded member axially supported for rotation and operatively connected to said guide so as to permit movement of said guide along said path by rotation of said threaded member.

7. The adjustable seat assembly of claim 6 wherein said threaded member is operatively connected to a motor.

8. The adjustable seat assembly of claim 1 further including a control operatively connected to said guide to control the movement of said seat.

9. An adjustable seat assembly comprising:
a seat with a front end and a rear end;
at least a first guide with a first slope sloping upward toward said front end and at least a second guide with a second slope sloping upward toward said rear end; and
a seat operatively connected to said first slope and said second slope so as to permit movement of said seat along said first slope and said second slope

10. The adjustable seat assembly of claim 9 wherein said first guide is supported to permit movement along a path such that its movement toward said second guide causes said front end to rise and movement away from said second guide causes said front end to fall.

11. The adjustable seat assembly of claim 9 wherein said second guide is supported to permit movement along a path such that its movement toward said first guide causes said rear end to rise and movement away from said first guide causes said front end to fall.

12. The adjustable seat assembly of claim 9 wherein said first guide and said second guide are supported to permit movement along a path such that their movement toward each other causes said seat to rise and movement away from each other causes said seat to fall.

13. The adjustable seat assembly of claim 9 wherein said seat is operatively connected to said first slope and said second slope so as to permit movement of said seat along said first slope and said second slope without movement along said path.

14. The adjustable seat assembly of claim 10 further including a first threaded member axially supported for rotation and operatively connected to said first guide so as to permit movement of said first guide along said path by rotation of said first threaded member.

15. The adjustable seat assembly of claim 14 wherein said first threaded member is operatively connected to a first motor.

16. The adjustable seat assembly of claim 11 further including a second threaded member axially supported for rotation and operatively connected to said second guide so as to permit movement of said second guide along said path by rotation of said second threaded member.

17. The adjustable seat assembly of claim 16 wherein said second threaded member is operatively connected to a second motor.

18. The adjustable seat assembly of claim 9 further including a control operatively connected to said first guide and said second guide to control the movement of said seat.

19. An adjustable seat assembly comprising;
a seat;
a backrest with at least a first pivot operatively connecting said backrest to said seat;
a threaded member axially supported for rotation and operatively connected to said backrest so as to permit movement of said backrest by rotation of said threaded member; and
a second pivot operatively connecting said threaded member to said backrest.

20. The adjustable seat assembly of claim 19 wherein said threaded member is operatively connected to a motor.

21. The adjustable seat assembly of claim 19 wherein said second pivot is a ball joint.

22. The adjustable seat assembly of claim 19 further including a control operatively connected to said backrest so as to control its movement.

23. An adjustable seat assembly comprising:
a seat;
a backrest operatively connected to said seat;
a headrest supported for movement and operatively connected to said backrest; and
a motor operatively connected to said headrest.

24. The adjustable seat assembly of claim 23 further including a threaded member operatively connecting said head rest to said motor so as to permit movement of said headrest by rotation of said threaded member.

25. The adjustable seat assembly of claim 23 further including a control operatively connected to said headrest so as to control the movement of said headrest.

26. An adjustable seat assembly comprising:
at least one guide with a slope supported for movement along a path;
a seat operatively connected to said slope and supported to permit movement of said seat along said slope without movement along said path of said guide;
a backrest with at least a first pivot operatively connecting said backrest to said seat;
a first threaded member axially supported for rotation and operatively connected to said backrest so as to permit movement of said backrest by rotation of said threaded member;
a second pivot operatively connecting said threaded member to said backrest;
a headrest operatively connected to said backrest with motor operatively connected to said headrest; and
a second threaded member axially supported for rotation and operatively connected to said headrest so as to permit movement of said headrest by rotation of said second threaded member.

27. The adjustable seat assembly of claim 26 further including a frame operatively connected to said seat

28. The adjustable seat assembly of claim 27 wherein said seat is slidably connected to said frame.
